(19) United States
(12) Patent Application Publication
(10) Pub. No.: US 2026/0220030 A1
(43) Pub. Date: Jul. 30, 2026

(54) AUTO-GENERATED UNIVERSAL SIMULATOR FOR TESTING

(71) Applicant: Dell Products L.P., Round Rock, TX (US)

(72) Inventors: Supriya Deshmukh, Singapore (SG); Lavanya Rameshkupar, Singapore (SG); Bao Shin Yeo, Singapore (SG); Li Ching Soong, Singapore (SG); Dewi Sendjaja, Singapore (SG)

(21) Appl. No.: 19/037,026

(22) Filed: Jan. 24, 2025

(51) Int. Cl. G06F 11/3668

(52) U.S. Cl. CPC G06F 11/3688; G06F 11/368; G06F 11/3692

(57) ABSTRACT

A method for testing operations of a computing environment includes obtaining, by a universal simulator, a request for recording a scenario in the computing environment, in response to the request: initiating a recording session of interactions between computing components in the computing environment, storing recorded actions each associated with one of the interactions in a simulator database, performing a playback using the recorded actions, and performing a remediation of the operations based on results of performing the playback.

### BACKGROUND

Performing operations testing of a computing environment may require time and resources. During the operations testing, any number of factors may cause a failure in a system under test (such as the computing environment). Identifying the factors that cause the failure may be beneficial for the purposes of the operations testing. Discovering the factors during the operations testing may be a cumbersome task.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1 shows a diagram of a system in accordance with one or more embodiments of the invention.

FIG. 2 shows a flowchart of a method for recording actions of a scenario in accordance with one or more embodiments of the invention.

FIG. 3 shows a flowchart of a method for managing a playback session in accordance with one or more embodiments of the invention.

FIG. 4.1-4.2 show example interactions between components of the system in accordance with one or more embodiments of the invention.

FIG. 5 shows a diagram of a computing device in accordance with one or more embodiments of the invention.

### DETAILED DESCRIPTION

Specific embodiments will now be described with reference to the accompanying figures. In the following description, numerous details are set forth as examples of the invention. It will be understood by those skilled in the art that one or more embodiments of the present invention may be practiced without these specific details, and that numerous variations or modifications may be possible without departing from the scope of the invention. Certain details known to those of ordinary skill in the art are omitted to avoid obscuring the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

As used herein, the phrase operatively connected, operably connected, or operative connection, means that there exists between elements, components, and/or devices a direct or indirect connection that allows the elements to interact with one another in some way. For example, the phrase ‘operably connected’ may refer to any direct (e.g., wired directly between two devices or components) or indirect (e.g., wired and/or wireless connections between any number of devices or components connecting the operably connected devices) connection. Thus, any path through which information may travel may be considered an operable connection.

Embodiments of the invention include systems and methods for managing operations of a computing environment. Specifically, embodiments of the invention include a universal simulator that monitors interactions between computing components (e.g., computing devices or services) in the computing environment to obtain recorded actions. The interactions may include synchronous actions such as API calls and asynchronous actions such as messages. The interactions may be intercepted by the universal simulator and stored in a simulator database. The recorded actions may each be associated with a scenario such as a workload executed by the computing environment.

The universal simulator may further include functionality for performing a playback session of a scenario using the corresponding recorded actions by simulating at least one of the computing components, tracking and evaluating the actions of the scenario, and generating the results. Based on the results, embodiments of the invention include performing remediation on one or more of the computing components.

Various embodiments of the invention are described below.

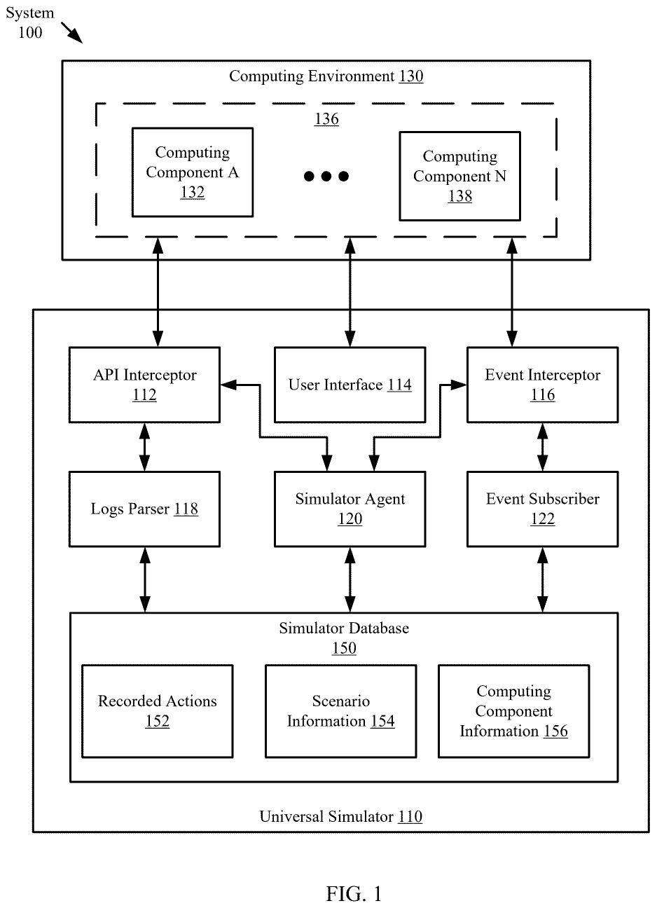

FIG. 1 shows a diagram of a system in accordance with one or more embodiments of the invention. The system (100) includes a computing environment (130) and a universal simulator (110). The system (100) of FIG. 1 may include additional, different, and/or different components without departing from the invention.

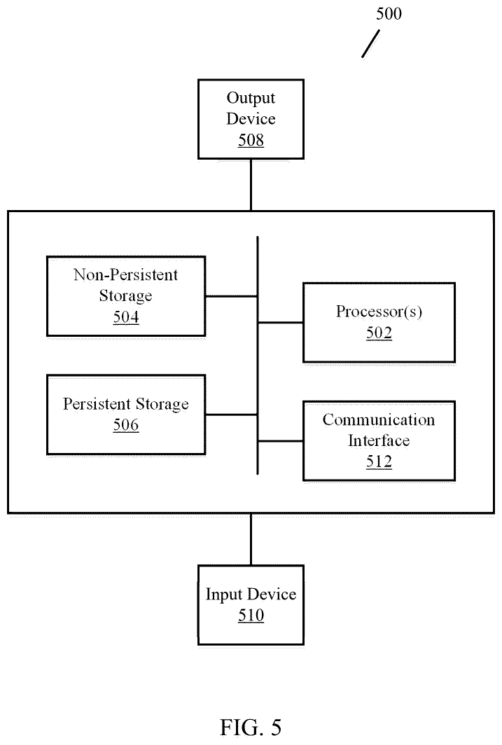

In one or more embodiments, the computing environment (130) includes functionality for providing computing services to users (not shown) or other entities using workloads. The computing environment (130) may be implemented as an environment of computing devices (see, e.g., FIG. 5). The computing devices may utilize any number of computing components (136). One or more computing components (132, 138) may each be a computing device. Alternatively, one or more computing components (132, 138) may be implemented as services such as applications. The computing components (132, 138) may interact with each other using actions such as application programming interface (API) calls or asynchronous messages. The asynchronous messages may be obtained using an event framework (implemented as one of the computing components (132, 138)) that manages a message query wherein the computing components (136) subscribe to events and respond accordingly.

In one or more embodiments, the computing environment (130) is implemented as a computing device (see e.g., FIG. 5). The computing device may be, for example, a laptop computer, a desktop computer, a server, a distributed computing system, or a cloud resource (e.g., a third-party storage system accessible via a wired or wireless connection). The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the computing environment (130) described throughout this application.

In one or more embodiments disclosed herein, the computing environment (130) is implemented as a logical device. The logical device may utilize the computing resources of any number of computing devices and thereby provide the functionality of the computing environment (130) described throughout this application.

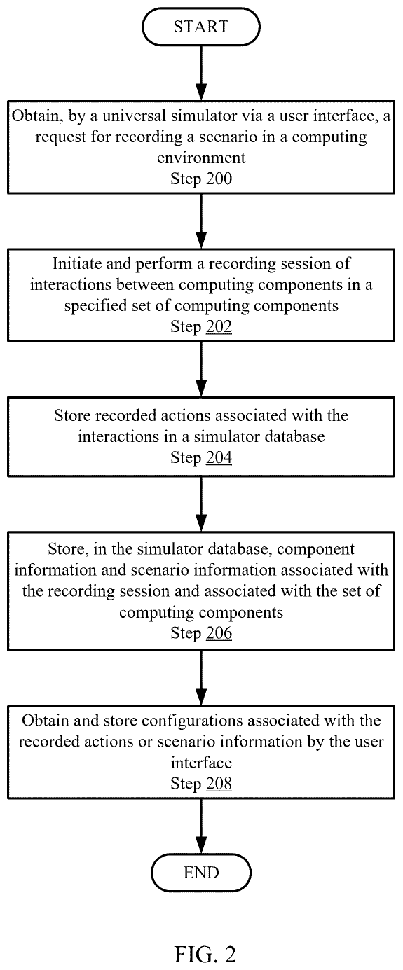

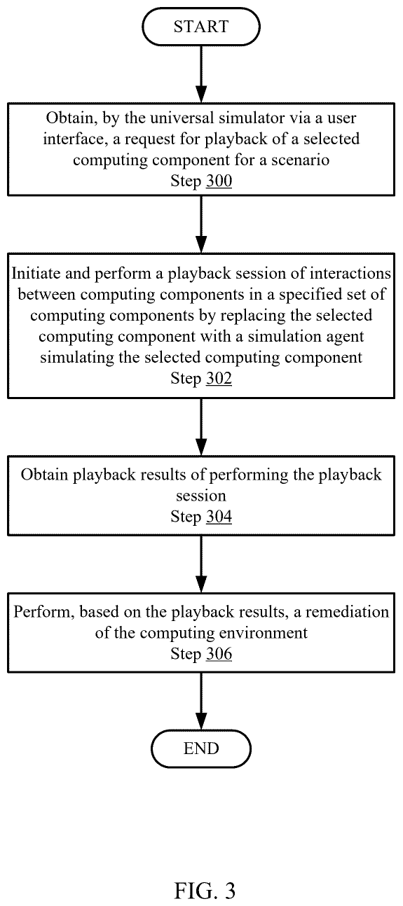

In one or more embodiments, at least a portion of the computing components (132, 138) of the computing environment (130) undergo operational testing. The computing components (136) may undergo operational testing by the universal simulator (110). The universal simulator (110) may perform the operational testing in accordance with the method of FIGS. 2 and 3.

To perform the aformentioned functionality, the universal simulator (110) includes an API interceptor (112), a user interface (114), an event interceptor (116), a logs parser (118), a simulator agent (120), an event subscriber (122), and a simulator database (150). The universal simulator (110) may include additional, fewer, and/or different components without departing from the invention.

The API interceptor (112) may be implemented as an interface between the computing components (136) and the universal simulator (110) that collects API related information intercepted between the computing components (132, 138). As an example, for a computing environment using Istio as a service mesh, a proxy component may be deployed in each computing component (132, 138) to mediate inbound and outbound traffic for all services in the mesh. The access logging may then be enabled using a telemetry API or a mesh configuration. The log parser (118) may access the logs from the API interceptor (112) and populate the data into the simulator database (150) as recorded actions (152) associated with the API calls. Data that is stored by the log parser (118) obtained from the API interceptor (112) includes, but not limited to: API start or end time, the API request payload, the API request header, the API response header, and the API response payload.

The event interceptor (116) includes functionality for reading the event framework of the computing environment (130) such as a messaging system. The event interceptor (116) may be implemented as a listener that subscribes to all event streams. For an example messaging system, the listener may subscribe to wildcard characters such as “>”, and receive any messages sent to the event framework. The messages may be obtained by the event subscriber (122) that parses and populates the messages into the simulator database (150) in the recorded actions.

The user interface (114) may provide users with a platform to access, review, and validate the data captured during the playback and recording sessions. The user interface (114) may offer any tools or features that enable the users to examine the stored information, ensuring its accuracy and completeness. The user interface (114), for example, may provide modifications and configurations of the stored recorded actions (152) prior to a playback session to obtain comprehensive and accurate results.

The simulator agent (120) includes functionality for executing playback sessions by simulating one or more computing components (136) in accordance with FIG. 3. The simulator agent (120) may intercept API calls or events during the playback and search the simulator database (150) to compare the extracted actions (e.g., the intercepted API calls or events) to corresponding recorded actions captured during a recording session. The recording session may be implemented using the method of FIG. 2. Based on the comparison, the universal simulator (110) may include functionality for performing remediation actions in accordance with FIG. 3.

The simulator agent (120) further includes functionality for applying service simulation context to a playback by identifying the service being simulated during the playback to ensure that the remediation is relevant to the results of the simulation. Based on such service simulation context, the simulator agent (120) may evaluate the results and maintain the continuity and flow of the testing environment (e.g., the computing components (136) under test) by accurately replaying recorded actions using a simulated component. This may ensure that the testing scenarios remain consistent and reliable, allowing for effective validation and verification of the system under test.

In one or more embodiments, the information included in the recorded actions (152) includes: an identifier of each recorded action, a related scenario identifier based on the scenario information (154), a type of recorded action (e.g., API call or event), a timestamp, an API endpoint, an API header, an API query parameters included in the API request, an API request payload, an API response status code, an API response header, an API response body, an API response time, a source component name of the source computing component (e.g., using the computing component information (156)), a destination component name of a computing component, a subject of the event, an event extension that includes additional data of the event, an event body. For the above information, the API information such as API header, API request payload, etc. may apply only to such recorded actions (130) that are API calls. Conversely, the above information that describes an event may only be applicable to such recorded actions (130) that are events.

In one or more embodiments, the scenario information (154) includes information about one or more scenarios. In one or more embodiments, a scenario refers to a grouping of interactions between computing components (136) for one workflow executed within a period of time. A recording session in accordance with the method of FIG. 2 may be performed on a per-scenario basis. The information in the scenario information (154) may include, for example, an identifier for each scenario, a name of the scenario (e.g., assigned by a user or defaulting to the first component and a time of creation), scenario parameters that include user-defined variables for API calls or event payloads, and/or any other information associated with a scenario without departing from the invention.

In one or more embodiments, the computing component information (156) includes information related to each computing component (132, 138) in the computing environment (130). The information in the computing component information (156) includes, but is not limited to: a component identifier, a network address (e.g., an internet protocol (IP) address) to access the computing component, and a uniform resource locator (URL) of the computing component.

FIG. 2 shows a flowchart of a method for recording actions of a scenario in accordance with one or more embodiments of the invention. The method shown in FIG. 2 may be performed by, for example, a universal simulator (110, FIG. 1). Other components of the system illustrated in FIG. 1 may perform the method of FIG. 2 without departing from the invention. While the various steps in the flowchart are presented and described sequentially, one of ordinary skill in the relevant art will appreciate that some or all of the steps may be executed in different orders, may be combined or omitted, and some or all steps may be executed in parallel.

Turning to FIG. 2, in step 200, a request for recording a scenario in a computing environment is obtained. The request may be obtained from a user interacting with the universal simulator via a user interface. The request may specify a computing component to undergo testing operations for a given scenario (e.g., for a workload initiated by one of the computing components in the computing environment).

In response to the request, the universal simulator may generate a system under test (SUT) associated with the scenario. The SUT may be a grouping of computing components involved in interactions for a scenario. The scenario may be, for example, the servicing an API request using multiple computing devices and/or services, using an event framework, or using any computing component in the computing environment. Each computing component determined to be involved with the scenario (e.g., by the user) is included in the SUT. The computing component information (156, FIG. 1) is updated with the component information associated with each computing component of the SUT.

In step 202, a recording session is initiated. In one or more embodiments, the recording session includes installing (or otherwise activating) an API interceptor (112, FIG. 1) and an event interceptor (116, FIG. 1) to gather information associated with interactions between computing components in the SUT. The computing components interact using actions such as, for example: issuing or obtaining API requests, issuing to or obtaining messages from a message queue managed by an event framework, issuing or obtaining API responses, and/or any other interactions without departing from the invention. The API interceptor may obtain information used to generate recorded actions corresponding to an API call such as API requests and API responses. The event interceptor may obtain information used to generate recorded actions corresponding to events (e.g., asynchronous messages). A scenario may be deemed completed when the request initiating the scenario (e.g., a first API request) is responded to. The response may indicate a success in completing the requested workload or a failure without departing from the invention. After the scenario is completed, the recording session may end.

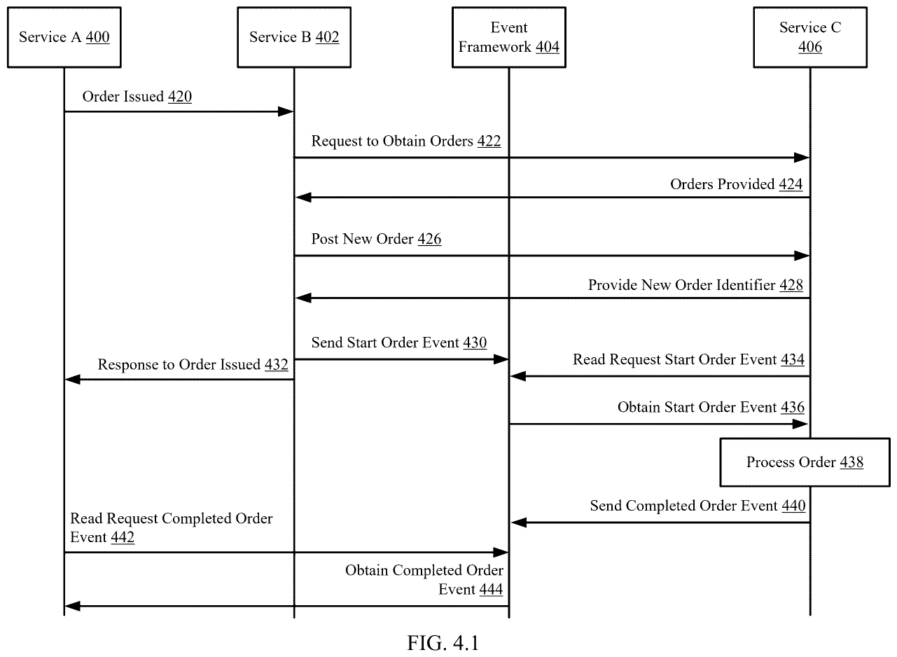

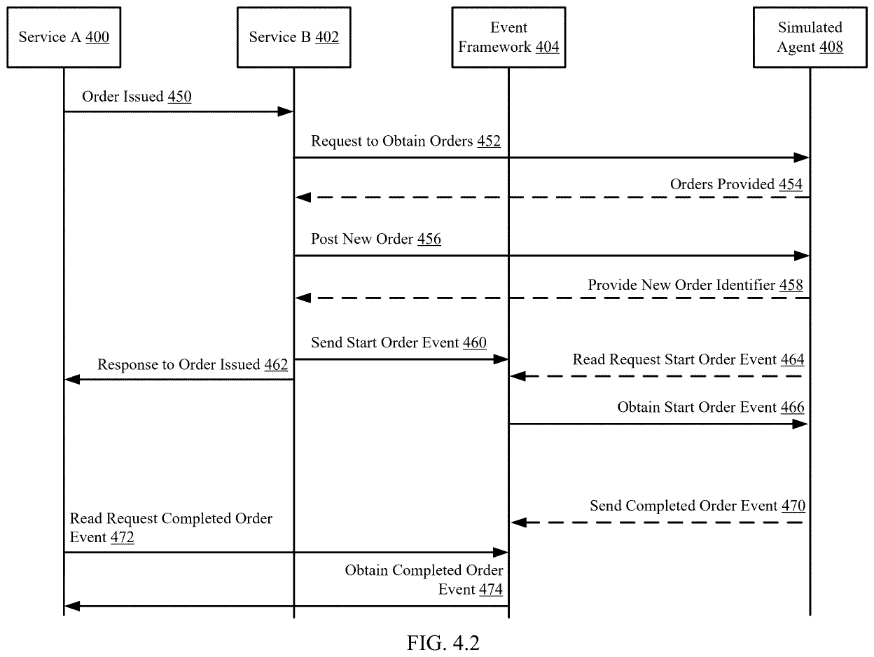

An example scenario is described using FIG. 4.1 below.

In step 204, recorded actions (152, FIG. 1) associated with the interactions are stored in a simulator database. The recorded actions may each specify the scenario described throughout FIG. 2.

In step 206, component information and scenario information are stored. In one or more embodiments, any information associated with each computing component is stored as computing component information (156, FIG. 1) as described above. Further, the scenario information (154, FIG. 1) is stored using a table corresponding to the scenario.

In step 208, configurations associated with the recorded actions are obtained from the user and stored. In one or more embodiments, the user validates the recorded actions by reviewing the information stored in steps 204 and 206 to apply any configurations to the data. The configurations may include modifying one or more values of the device, deleting one or more recorded actions deemed unnecessary for evaluation, renaming the scenario, adding additional parameters, converting one or more fields in a recorded action to configurable variables such as a correlation identifier that maps the field to other fields or to other information in the simulator database, or other modifications that aid in performing a playback in accordance with FIG. 3 below. The configurations may be stored with the recorded actions.

FIG. 3 shows a flowchart of a method for managing a playback session in accordance with one or more embodiments of the invention. The method shown in FIG. 3 may be performed by, for example, a universal simulator (110, FIG. 1). Other components of the system illustrated in FIG. 1 may perform the method of FIG. 3 without departing from the invention. While the various steps in the flowchart are presented and described sequentially, one of ordinary skill in the relevant art will appreciate that some or all of the steps may be executed in different orders, may be combined or omitted, and some or all steps may be executed in parallel.

In step 300, a request for playback of a selected computing component is obtained. The request for the playback may be associated with the request for a recording discussed in FIG. 2 above. Further, the request may specify a scenario for evaluation. The playback may include performing a playback session associated with the specified scenario, generating playback results, and performing the remediation in accordance with the playback results. The selected computing component may be replaced by a simulator agent (120, FIG. 1) that simulates the selected computing component by performing actions in accordance with the recorded actions corresponding to the scenario.

In step 302, a playback session is initiated and performed. In one or more embodiments, the playback session is initiated using an API request that corresponds to initiating the scenario to the corresponding computing component. The computing components in the SUT (with the exception of the selected computing component), and the simulator agent simulating the selected computing component, may interact in accordance with the servicing of the initial API request. The interactions may be monitored by the universal simulator.

For example, the API interceptor (112, FIG. 1) intercepts any API requests intended for the selected computing component and provides such requests to the simulator agent (120) to behave in accordance with the simulation of the selected computing component using the recorded actions. For example, if the recorded actions indicate that the selected computing component served a similar API request four milliseconds after obtaining the request, the simulator agent may mimic such latency and generate an API response accordingly. Similarly, the event interceptor (116, FIG. 1) may intercept any messages corresponding to the selected computing component and provide such messages to the simulator agent for processing. The simulator agent may, in turn, simulate to the asynchronous messages according to the recorded actions.

The playback session may be deemed complete after either the initial API request of the scenario is responded to or after a failure of the scenario is detected. An example of a playback session completed after a successful servicing of the initial API request is described using FIG. 4.2 below.

In step 304, playback results are obtained based on the playback session. In one or more embodiments, the playback results may indicate a failure if one of the following example results occurs: an expected API request in the playback session is incorrect relative to the recorded actions, an expected API response is incorrect relative to the recorded actions, an expected event is incorrect relative to the recorded actions, or an expected request or response was not obtained by the simulator agent. In contrast, the playback results may indicate a success if all (or a predefined percentage or threshold number) of the expected recorded actions are performed in the playback session.

In step 306, a remediation of the computing environment is performed based on the playback results. In one or more embodiments, the remediation includes selecting a different computing component in the SUT for simulation and evaluation and initiating another playback session with the new selected computing component. Steps 302 and 304 may be applied to the new selected computing component to obtain new playback results.

The playback results of the playback session (and of any additional playback session performed for the requested scenario) may be used for additional evaluation. For example, if the playback results indicate that one of the computing components in the SUT is causing failures in servicing the initial API requests, the remediation may include replacing the disruptive component (i.e., a computing component that fails to perform recorded actions as expected), modifying the scenario for future operations (e.g., future workloads) executed in the computing environment. Other remediations may be performed based on the evaluation of the playback results without departing from the invention.

### Example Scenario

To clarify aspects of the invention, the following describes an example in accordance with one or more embodiments of the invention. Turning to the example, consider a scenario in which a system under test (SUT) includes a set of computing components such as service A, service B, service C, and an event framework managing a message queue. A scenario may include issuing an order initiated by service A.

Turning to FIG. 4.1, service A (400) is a user interface issuing a request to process an order to service B (402). The order is issued in step 420. Service B (402), in response to receiving the issued order, sends a request to obtain a list of orders from service C (406). The request to obtain orders is issued in step 422. Service C (406) in response to obtaining the request to obtain orders (422), provides the list of orders. The list of orders is provided in step 424.

In response to obtaining the list of orders, service B (402) issues a request to post a new order. The request to post a new order is issued in step 426. Service C (406) responds to the request to post a new order (426) by providing a new order identifier (428) associated with the posted order. Service B (402) issues an asynchronous message (430) to the message queue of the event framework (404). The asynchronous message (430) specifies processing the new order. In step 432, service B (402) responds to the request to issue the order to indicate that the order is issued.

In step 434, service C (406) reads the message queue to identify the new message (430). In step 438, service C (406) processes the order. In step 440, service C (406) issues an asynchronous message (440) that indicates completion of the order.

In step 442, service A (400), being subscribed to the event framework (404), reads the completed order event. The completed order event is obtained by service A (400) in step 444.

After the actions illustrated in FIG. 4.1 are performed, the universal simulator (110, FIG. 1) stores recorded actions that specify information about each of the aforementioned actions. In this manner, the universal simulator is equipped to simulate actions of any of the computing components (400, 402, 404, 406) in the SUT during a playback session. FIG. 4.2 below shows an example playback session that includes simulating service C (406).

### End of Example Scenario

### Example Playback Session

To clarify aspects of the invention, the following describes an example in accordance with one or more embodiments of the invention. Turning to the example, consider a scenario in which a playback session is performed by simulating service C (406, FIG. 4.1) discussed above. The playback session may be initiated by instructing service A (400) to reissue the order discussed in FIG. 4.1. Any synchronous or asynchronous messages issued to service C may be intercepted by a universal simulator (not shown). A simulated agent (408) of the universal simulator may respond in accordance with the obtained recorded actions discussed in FIG. 4.1.

Turning to FIG. 4.2, service A (400) issues a second request to process an order to service B (402). The order is issued in step 450. Service B (402), in response to receiving the issued order, sends a request to obtain a list of orders from service C (406). The request to obtain orders is issued in step 452. The simulated agent (408), in response to intercepting the request to obtain orders (452), provides the list of orders in accordance with the recorded action in the recording session. The list of orders is provided in step 454.

In response to obtaining the list of orders, service B (402) issues a request to post a new order. The request to post a new order is issued in step 456. The simulated agent (408) responds to the request to post a new order (456) by providing a new order identifier (458) associated with the posted order. Service B (402) issues an asynchronous message (460) to the message queue of the event framework (404). The asynchronous message (460) specifies processing the new order. In step 462, service B (402) responds to the request to issue the order to indicate that the order is issued.

In step 464, the simulated agent (408) reads the message queue to identify the new message (460). In step 470, the simulated agent (408) responds in accordance with the recorded actions and issues an asynchronous message (470) that indicates completion of the order.

In step 472, service A (400), being subscribed to the event framework (404), reads the completed order event. The completed order event is obtained by service A (400) in step 474.

Given the playback session discussed herein performs the actions in a similar manner to the recording session discussed in FIG. 4.1, the playback session of FIG. 4.2 may indicate successful results. In one or more embodiments, additional playback sessions may be performed for the other services (400, 402, 404) in the SUT to obtain additional playback results and to identify any disruptive components and/or any other failure points to be remediated.

### End of Example Playback Session

As discussed above, embodiments of the invention may be implemented using computing devices. FIG. 5 shows a diagram of a computing device in accordance with one or more embodiments of the invention. The computing device (500) may include one or more computer processors (502), non-persistent storage (504) (e.g., volatile memory, such as random access memory (RAM), cache memory), persistent storage (506) (e.g., a hard disk, an optical drive such as a compact disk (CD) drive or digital versatile disk (DVD) drive, a flash memory, etc.), a communication interface (512) (e.g., Bluetooth interface, infrared interface, network interface, optical interface, etc.), input devices (510), output devices (508), and numerous other elements (not shown) and functionalities. Each of these components is described below.

In one embodiment of the invention, the computer processor(s) (502) may be an integrated circuit for processing instructions. For example, the computer processor(s) may be one or more cores or micro-cores of a processor. The computing device (500) may also include one or more input devices (510), such as a touchscreen, keyboard, mouse, microphone, touchpad, electronic pen, or any other type of input device. Further, the communication interface (512) may include an integrated circuit for connecting the computer (500) to a network (not shown) (e.g., a local area network (LAN), a wide area network (WAN) such as the Internet, mobile network, or any other type of network) and/or to another device, such as another computing device.

In one embodiment of the invention, the computing device (500) may include one or more output devices (508), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (502), non-persistent storage (504), and persistent storage (506). Many different types of computing devices exist, and the aforementioned input and output device(s) may take other forms.

One or more embodiments of the invention may be implemented using instructions executed by one or more processors of the data management device. Further, such instructions may correspond to computer readable instructions that are stored on one or more non-transitory computer readable mediums.

One or more embodiments of the invention may improve the operation of one or more computing devices. More specifically, embodiments of the invention provide robust multi-component coverage of a computing environment to provide simulation of complex interactions across multiple components. Such coverage may ensure thorough testing and validation of integrated systems. Embodiments of the invention further provide user-friendly configuration of recorded actions post-recording for accurate and useful evaluation of playback results that may result in remediating the operations of the computing environment. Embodiments of the invention further include accessible testing setup that enables precise customization and fine-tuning of mock services to reflect real-world scenarios accurately. Embodiments of the invention further include streamlined testing workflows by reducing the time and effort required to set up mock services and accelerating the testing cycle, enabling faster identification and resolution of issues in the computing environment.

Thus, embodiments of the invention may address the problem of inefficient use of computing resources. This problem arises due to the technological nature of the environment in which file systems are utilized.

The problems discussed above should be understood as being examples of problems solved by embodiments of the invention disclosed herein and the invention should not be limited to solving the same/similar problems. The disclosed invention is broadly applicable to address a range of problems beyond those discussed herein.

While the invention has been described above with respect to a limited number of embodiments, those skilled in the art, having the benefit of this disclosure, will appreciate that other embodiments can be devised which do not depart from the scope of the invention as disclosed herein. Accordingly, the scope of the invention should be limited only by the attached claims.

What is claimed is:

1. A method for managing operations in a computing environment, the method comprising:
obtaining, by a universal simulator, a request for recording a scenario in the computing environment;
in response to the request:
initiating a recording session of interactions between computing components in the computing environment;
storing recorded actions each associated with one of the interactions in a simulator database;
performing a playback using the recorded actions; and
performing a remediation of the operations based on results of performing the playback.

2. The method of claim 1, wherein performing the playback comprises:
obtaining a second request for the playback of a selected computing component of the computing components;
performing, based on the recorded actions, a playback session of second interactions between a subset of the computing components and with a simulation agent simulating the selected computing component,
wherein the subset of the computing components consists of the computing components without the selected computing component; and
obtaining the results based on the playback session.

3. The method of claim 2, wherein the results indicate that at least one of the recorded actions is not performed as expected by a disruptive component, wherein the disruptive component is either one of the subset of computing components or the simulation agent.

4. The method of claim 3, wherein the remediation comprises at least one of: replacing the disruptive component, modifying the scenario for future operations in the computing environment, and initiating a second playback session for a second selected computing component of the computing components.

5. The method of claim 2, further comprising:
after completing the recording session, storing configurations associated with the recorded actions, wherein the playback session is performed using the configurations.

6. The method of claim 1, wherein a first interaction of the interactions is an application programming interface (API) call, and wherein a second interaction of the interactions is an event.

7. The method of claim 6, wherein the event is an asynchronous message stored in a message queue.

8. A non-transitory computer readable medium comprising computer readable program code, which when executed by a computer processor enables the computer processor to perform a method for managing operations in a computing environment, the method comprising:
obtaining, by a universal simulator, a request for recording a scenario in the computing environment;
in response to the request:
initiating a recording session of interactions between computing components in the computing environment;
storing recorded actions each associated with one of the interactions in a simulator database;
performing a playback using the recorded actions; and
performing a remediation of the operations based on results of performing the playback.

9. The non-transitory computer readable medium of claim 8, wherein performing the playback comprises:
obtaining a second request for the playback of a selected computing component of the computing components;
performing, based on the recorded actions, a playback session of second interactions between a subset of the computing components and with a simulation agent simulating the selected computing component,
wherein the subset of the computing components consists of the computing components without the selected computing component; and
obtaining the results based on the playback session.

10. The non-transitory computer readable medium of claim 9, wherein the results indicate that at least one of the recorded actions is not performed as expected by a disruptive component, wherein the disruptive component is either one of the subset of computing components or the simulation agent.

11. The non-transitory computer readable medium of claim 10, wherein the remediation comprises at least one of: replacing the disruptive component, modifying the scenario for future operations in the computing environment, and initiating a second playback session for a second selected computing component of the computing components.

12. The non-transitory computer readable medium of claim 9, further comprising:
after completing the recording session, storing configurations associated with the recorded actions, wherein the playback session is performed using the configurations.

13. The non-transitory computer readable medium of claim 8, wherein a first interaction of the interactions is an application programming interface (API) call, and wherein a second interaction of the interactions is an event.

14. The non-transitory computer readable medium of claim 13, wherein the event is an asynchronous message stored in a message queue.

15. A system comprising:
a universal simulator, operating on a processor;
a computing environment comprising computing components; and
memory comprising instructions, which when executed by the processor, perform a method comprising:
obtaining a request for recording a scenario in the computing environment;
in response to the request:
initiating a recording session of interactions between the computing components;
storing recorded actions each associated with one of the interactions in a simulator database;
performing a playback using the recorded actions; and
performing a remediation of the operations based on results of performing the playback.

16. The system of claim 15, wherein performing the playback comprises:
obtaining a second request for the playback of a selected computing component of the computing components;
performing, based on the recorded actions, a playback session of second interactions between a subset of the computing components and with a simulation agent simulating the selected computing component,
wherein the subset of the computing components consists of the computing components without the selected computing component; and
obtaining the results based on the playback session.

17. The system of claim 16, wherein the results indicate that at least one of the recorded actions is not performed as expected by a disruptive component, wherein the disruptive component is either one of the subset of computing components or the simulation agent.

18. The system of claim 17, wherein the remediation comprises at least one of: replacing the disruptive component, modifying the scenario for future operations in the computing environment, and initiating a second playback session for a second selected computing component of the computing components.

19. The system of claim 16, further comprising:
after completing the recording session, storing configurations associated with the recorded actions, wherein the playback session is performed using the configurations.

20. The system of claim 15,
wherein a first interaction of the interactions is an application programming interface (API) call,
wherein a second interaction of the interactions is an event, and
wherein the event is an asynchronous message stored in a message queue.
